(19) United States
(12) Patent Application Publication
(10) Pub. No.: US 2023/0421653 A1
(43) Pub. Date: Dec. 28, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: KEI TATENO, TOKYO (JP); MASAHIRO YOSHIDA, TOKYO (JP); TAKUMA UDAGAWA, TOKYO (JP)

(21) Appl. No.: 18/252,531

(22) PCT Filed: Nov. 4, 2021
(86) PCT No.: PCT/JP2021/040497

§ 371 Date: May 10, 2023

(30) Foreign Application Priority Data
Nov. 18, 2020 (JP) 2020-191475

(51) Int. Cl. H04L 67/50; H04L 67/306

(52) U.S. Cl. CPC H04L 67/535; H04L 67/306

(57) ABSTRACT

This technology relates to an information processing apparatus, an information processing method, and a program that can perform more effective intervention. An intervention processing system estimates an intervention effect obtained as a result of performing an intervention and, on the basis of the estimated intervention effect, generates an intervention material for use in a new intervention to be performed. This technology can be applied to intervention processing systems that intervene with users receiving offerings of a content distribution service.

### TECHNICAL FIELD

The present technology relates to an information processing apparatus, an information processing method, and a program. More particularly, the technology relates to an information processing apparatus, an information processing method, and a program that can perform more effective intervention.

### BACKGROUND ART

In recent years, masses of user-accessible content have been constantly on the rise, making it difficult for users to find their favorite content. Conversely, content production and distribution businesses have found it increasingly difficult to reach users and encourage them to view the distributed content due to severe competition.

Even if users reach a given webpage introducing content, they hesitate actually to act on the page unless it presents information regarding the content in a manner prompting the users to take concrete action (to view, purchase, etc.).

On the other hand, machine learning models based on action prediction are designed to predict the current action, i.e., the models merely predict whether or not a specific action will be taken in the near future. Thus, the machine learning models may not lead to providing effective information presentation.

Non-citation literature 1 describes techniques for estimating the causal effect (ATE: Average Treatment Effect) of interventions (information presentation) with a group of users. Also, there exist techniques called Uplift modeling or ITE (Individual Treatment Effect) estimation for predicting the causal effect of interventions with individual users (see NPL 2 or 3).

PTL 1 describes techniques which, at the time of estimating the causal effect of an intervention, provide users with explanations about a causal relation based on the causal effect.

### CITATION LIST

### Patent Literature

### [NPL 1]

Lunceford, J. K., et al., “Stratification and weighting via the propensity score in estimation of causal treatment effects: a comparative study,” Statistics In Medicine, 23(19), pp. 2937-2960, [online], 20 Sep. 2012, [searched on Oct. 8, 2020], Internet <URL: http://www.math.mcgill.ca/dstephens/PSMMA/Articles/lunceford_davidian_2004.pdf>

### [NPL 2]

Wager, S., Athey, S., “Estimation and Inference of Heterogeneous Treatment Effects using Random Forests,” J. of the American Statistical Association, Vol. 113, 2018, 1 Dec. 2015 [searched on Oct. 8, 2020], Internet <URL: https://www.tandfonline.com/doi/full/10.1080/01621459.2017.1319839>

### [NPL 3]

Kunzel, S. R., et al., “Meta-learners for Estimating Heterogeneous Treatment Effects using Machine Learning,” arXiv, 12 Jun. 2017, [searched on Oct. 8, 2020], Internet <URL: https://arxiv.org/abs/1706.03461>

### [PTL 1]

Japanese Patent Laid-open No. 2019-194849

### SUMMARY

### Technical Problems

However, whereas the techniques described in NPLs 1 through 3 can estimate the causal effect of an intervention, they fail to specify what kind of specific intervention needs to be performed.

To perform a highly effective intervention by use of the techniques disclosed in PTL 1 requires the involvement of humans; suitable settings need to be made for the intervention based on decisions in reference to the explanations of causal relations offered by the techniques disclosed in PTL 1.

The present technology has been devised in view of the above circumstances and provides techniques for performing more effective intervention.

### Solution to Problems

According to one aspect of the present technology, there is provided an information processing apparatus including an information processing section configured to estimate an intervention effect obtained as a result of performing an intervention and, on the basis of the estimated intervention effect, to generate an intervention material for use in a new intervention to be performed.

According to the above aspect of the preset technology, an intervention effect obtained as a result of performing an intervention is estimated. On the basis of the estimated intervention effect, an intervention material is generated for use in a new intervention to be performed.

### BRIEF DESCRIPTION OF DRAWINGS

FIG. 1 is a block diagram depicting a functional configuration of an intervention processing system as a first embodiment of the present technology.

FIG. 2 is a flowchart explaining how the intervention processing system operates.

FIG. 3 is a tabular view listing typical user logs stored in a user log storage section.

FIG. 4 is a tabular view listing typical user feature quantities for use by an intervention effect estimation section.

FIG. 5 is a tabular view listing typical configurations of models for estimating intervention effects.

FIG. 6 is a tabular view listing typical estimated intervention effects stored in an estimated intervention effect storage section.

FIG. 7 is a tabular view listing typical feature quantities of interventions stored in an intervention material storage section.

FIG. 8 is a diagram depicting a typical decision tree as a typical intervention model.

FIG. 9 is a diagram depicting a typical intervention material editing screen.

FIG. 10 is a tabular view listing typical templates stored in a template storage section.

FIG. 11 is a tabular view listing typical intervention materials stored in the intervention material storage section.

FIG. 12 is a diagram depicting an example of Conditional GAN.

FIG. 13 is a diagram depicting a typical intervention confirmation screen.

FIG. 14 is a block diagram depicting a variation of the intervention processing system in FIG. 1.

FIG. 15 is a diagram depicting a typical extraction/editing screen.

FIG. 16 is a block diagram depicting a functional configuration of an intervention processing system as a second embodiment of the present technology.

FIG. 17 is a block diagram of a typical computer configuration.

### DESCRIPTION OF EMBODIMENTS

Embodiments for implementing the present technology are described below. The description to present the information below will be made in the following order:

1. First embodiment (content distribution service)

### 2. Variations

3. Second embodiment (healthcare-related service)

### 4. Others

### 1. First Embodiment

### Configuration Example of the Intervention Processing System

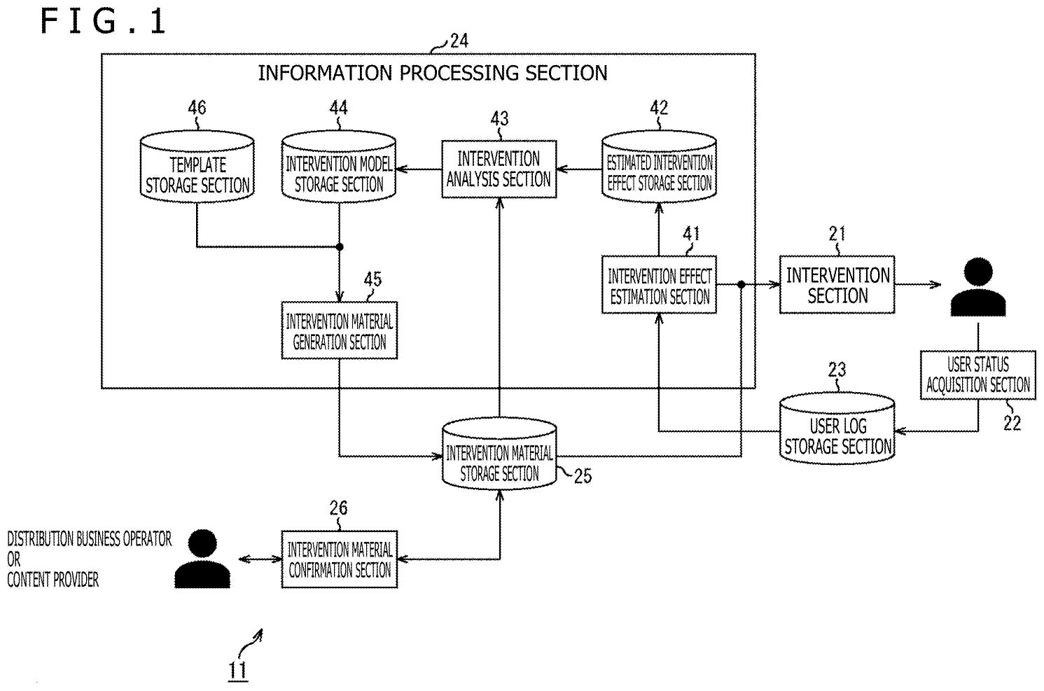

FIG. 1 is a block diagram depicting a functional configuration of an intervention processing system as a first embodiment of the present technology.

An intervention processing system 11 in FIG. 1 performs interventions with users receiving offerings of a content distribution service. The interventions involve presenting users with, for example, intervention materials for prompting them to act on the distributed content (i.e., to view, purchase, etc.). In this context, the intervention materials refer to the information presented to the users to urge them to act on the content. Thus, an intervention material includes at least one of such parts as a title, an image, and a catch-phrase. The position in which the intervention material is presented is, for example, a space within webpages where advertisements or recommendations are presented, or a spot within the information to be sent to users such as emails.

The functional configuration depicted in FIG. 1 is implemented by predetermined programs being executed by the CPU of a server, not depicted.

The intervention processing system 11 includes an intervention section 21, a user status acquisition section 22, a user log storage section 23, an information processing section 24, an intervention material storage section 25, and an intervention confirmation section 26.

The intervention section 21 intervenes with the user, i.e., with a display section of a user terminal. It is noted that one or multiple intervention materials are associated with each piece of content. Each intervention material is presented to one or multiple users.

The user status acquisition section 22 acquires, from a UI (User Interface) or sensors of the user terminal, information indicative of the action taken by the user as a result of the performed intervention, and outputs the acquired information to the user log storage section 23. It is noted that, even in a state where there is no intervention, the information indicative of the action taken by the user is acquired by the user status acquisition section 22.

The action taken by the user refers to a click or a tap made in response to an intervention made by the service (e.g., a thumbnail being presented), viewing of detailed content pages, actual viewing of the content, viewing completed or not, or a feedback such as good/bad or five-grade evaluation.

In a case where the acquired information is sensor data, the user status acquisition section 22 estimates the user's behavior (i.e., action taken by the user) from the user's facial expression or other biological information based on the sensor data. The user status acquisition section 22 outputs information indicative of the estimated behavior to the user log storage section 23.

The user log storage section 23 stores the information supplied from the user status acquisition section 22 as user logs. It is noted that the user log storage section 23 further storages the information regarding the interventions performed by the intervention section 21 (e.g., content IDs indicating which interventions were performed and intervention IDs identifying the interventions) in association with the user logs.

The information processing section 24 estimates an intervention effect obtained as a result of performing an intervention and, on the basis of the estimated intervention effect, generates an intervention material for use in a new intervention to be performed. It is noted that the intervention to be performed anew may include the case of using the intervention material generated by the information processing section 24 for the initial intervention, i.e., the case in which the intervention is updated.

Specifically, the information processing section 24 includes an intervention effect estimation section 41, an estimated intervention effect storage section 42, an intervention analysis section 43, an intervention model storage section 44, an intervention material generation section 45, and a template storage section 46.

The intervention effect estimation section 41 estimates the intervention effect of each intervention performed with an individual user (ITE: Individual Treatment Effect) by referencing the user logs in the user log storage section 23. The method for estimation may be one of those described in existing techniques, for example. The intervention effect estimation section 41 outputs estimated intervention effect data indicative of the estimated result of the intervention effect to the estimated intervention effect storage section 42.

It is noted that, as the intervention effect, ATE (Average Treatment Effect) or CATE (Conditional ATE) may alternatively be estimated.

The estimated intervention effect storage section 42 stores the estimated intervention effect data supplied from the intervention effect estimation section 41.

Using the estimated intervention effect data stored in the estimated intervention effect storage section 42, the intervention analysis section 43 learns an intervention model representing the relation between intervention feature quantities and user feature quantities on one hand and the estimated intervention effects on the other hand. The intervention feature quantities are either analyzed beforehand or stored manually in the intervention material storage section 25. It is noted that, in some cases, the relation between content feature quantities and the estimated intervention effects is learned.

For learning, a machine learning method is used which, with its interpretability, allows the intervention material generation section 45 downstream to easily interpret the relation between the feature quantities resulting from learning and the estimated intervention effects. Using the interpretable machine learning method makes it easy to let the results of learning be utilized downstream.

The intervention analysis section 43 outputs the learned intervention model to the intervention model storage section 44.

The intervention model storage section 44 stores the learned intervention model supplied from the intervention analysis section 43.

On the basis of the intervention model stored in the intervention model storage section 44, the intervention material generation section 45 generates an intervention material using the intervention feature quantities with a high ratio of contribution to intervention effects. The intervention material generation section 45 outputs the generated intervention material to the intervention material storage section 25.

For example, the intervention material generation section 45 acquires, from the intervention material storage section 25, multiple intervention material parts having a high ratio of contribution to intervention effects and combines the acquired intervention material parts into an intervention material. At this time, the intervention confirmation section 26 may be caused to present the intervention material parts to an intervention material creator (simply referred to as the creator hereunder) for selection purposes.

Alternatively, the intervention material generation section 45 may cause the intervention confirmation section 26, for example, to present the creator with templates including intervention material parts matching the feature quantities having a high ratio of contribution to intervention effects. A template is constituted of those parts configuring a complete intervention material, which form each of such variable elements as the number of people in an image and the position of the title therein. These templates are prepared manually beforehand.

The template storage section 46 stores the templates and information regarding the templates. The information regarding the templates includes template features, for example.

The intervention material storage section 25 stores the intervention materials, intervention material parts, and intervention feature quantities supplied from the intervention material generation section 45.

The intervention confirmation section 26 presents, for example, a content distribution business operator or a content owner with the intervention materials generated automatically by the intervention material generation section 45 and stored in the intervention material storage section 25, the presented intervention materials being for confirmation.

It is noted that, in a case where an intervention material is manually created, it is not mandatory for the content distribution business operator or the content owner to confirm the created material.

The intervention processing system 11 configured as described above may be formed in a server on a network. Alternatively, part of the intervention processing system 11 such as the intervention section 21 may be formed in the user terminal, and the rest of the system in the server. It is noted that the user terminal may be a smartphone or a personal computer owned by the user, for example.

<Typical Operations of the Intervention Processing System>

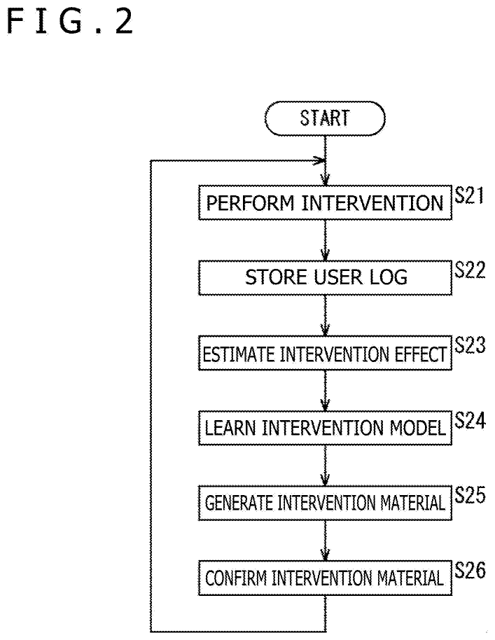

FIG. 2 is a flowchart explaining how the intervention processing system 11 operates.

In step S21, the intervention section 21 intervenes with the user receiving offerings of the content distribution service.

From the UI or the sensors of the user terminal, the user status acquisition section 22 acquires information indicative of the action taken by the user as a result of performing an intervention. The user status acquisition section 22 outputs the acquired information to the user log storage section 23.

In step S22, the user log storage section 23 stores the information supplied from the user status acquisition section 22 as a user log.

In step S23, the intervention effect estimation section 41 references the user logs in the user log storage section 23 to estimate the effect of each intervention with individual users, before outputting estimated intervention effect data to the estimated intervention effect storage section 42. The estimated intervention effect storage section 42 stores the estimated intervention effect data supplied from the intervention effect estimation section 41.

In step S24, the intervention analysis section 43 learns an intervention model representing the relation between the intervention feature quantities and user feature quantities on one hand and the estimated intervention effect on the other hand. The intervention model storage section 44 stores the intervention model supplied from the intervention analysis section 43.

In step S25, on the basis of the intervention model stored in the intervention model storage section 44, the intervention material generation section 45 generates an intervention material for use in an intervention using the intervention feature quantities having a high ratio of contribution to intervention effects. The intervention material generation section 45 outputs the generated intervention material to the intervention material storage section 25 for storage.

In step S26, the intervention confirmation section 26 causes the intervention material storage section 25 to present the content distribution business operator or the content owner with the intervention material stored therein for confirmation.

Thereafter, control is returned to step S21, and the processing of steps S21 through S26 is repeated.

By operating as described above, the intervention processing system 11 can perform more effective interventions.

The process in each of the steps in FIG. 2 is explained below in detail.

<Storage of User Logs>

Explained first are the user logs acquired at the time of performing the intervention in step S21 in FIG. 2 and stored in step S22.

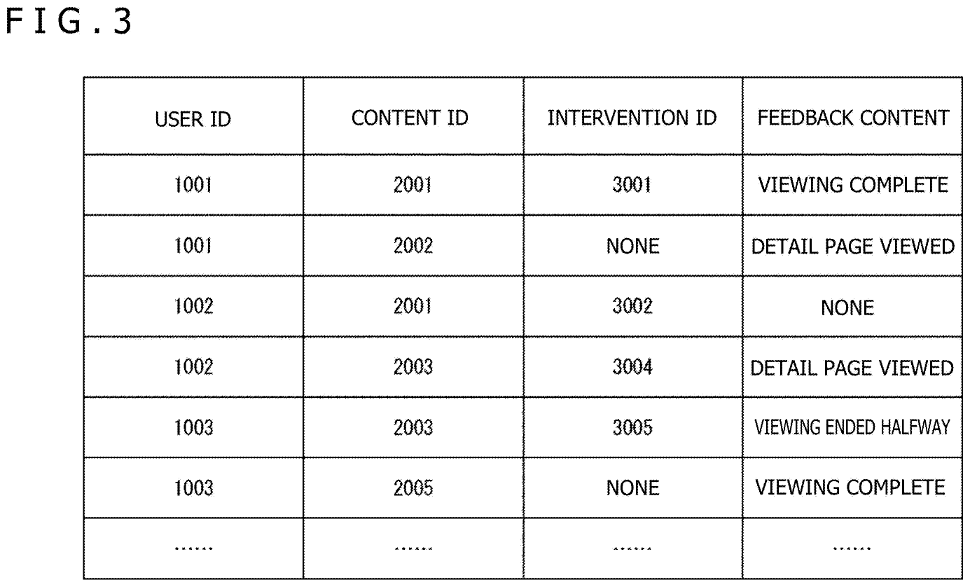

FIG. 3 is a tabular view listing typical user logs.

A user log includes a user ID, a content ID, an intervention ID, and feedback content.

The user ID is an identifier of the user. The content ID is an identifier of the content as the target of intervention. The intervention ID is an identifier of the intervention performed with the user. The feedback content includes information indicative of the content of the action taken by the user in a state where there was an intervention or in a state where there was no intervention.

Starting from the top of the list, the first user log indicates that the feedback content is “viewing complete” at the time of performing an intervention having an intervention ID “3001” in the content having a content ID “2001” with the user having a user ID “1001.”

The second user log indicates that the feedback content is “detail page viewed” in the state where there was no intervention in the content having a content ID “2002” with the user having the user ID “1001.”

The third user log indicates that the feedback content is “none” at the time of performing the intervention having an intervention ID “3002” in the content having a content ID “2001” with the user having a user ID “1002.”

The fourth user log indicates that the feedback content is “detail page viewed” at the time of performing the intervention having an intervention ID “3004” in the content having a content ID “2003” with the user having the user ID “1002.”

The fifth user log indicates that the feedback content is “viewing ended halfway” at the time of performing the intervention having an intervention ID “3005” in the content having a content ID “2003” with the user having a user ID “1003.”

The sixth user log indicates that the feedback content is “viewing complete” in the state where there was no intervention in the content having a content ID “2005” with the user having the user ID “1003.”

<Method of Estimating the Intervention Effect>

Explained next is how to estimate the intervention effect in step S23 in FIG. 2.

The intervention effect estimation section 41 estimates the intervention effect (ITE) on each individual user for each intervention. As a specific example, the method called “T-learner” described in the literature by Kunzel et al., is explained below. It is noted that what follows an explanation of an example in which the type of intervention does not matter, with the user logs distinguished from each other in terms of whether there was an intervention or not.

The intervention effect estimation section 41 divides the user logs into two cases: a case where there was an intervention and a case where there was no intervention. The intervention effect estimation section 41 learns models μ₁ and μ₀ for predicting objective variables from user feature quantities by use of existing regression and separation algorithms. The objective variable represents the user's action with respect to the content such as whether a purchase was made therein or whether viewing occurred. Information as to whether its viewing occurred is obtained from the feedback content of the user logs, for example.

Here, the model μ₁ is a model predicted on the basis of the user logs in “the case where there was an intervention.” The model μ₂ is a model predicted on the basis of the user logs in “the case where there was no intervention.”

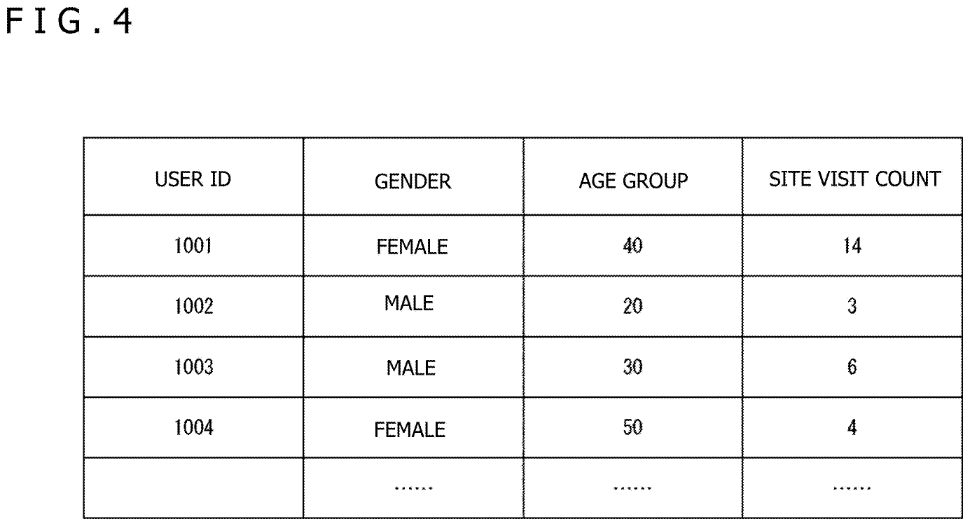

FIG. 4 is a tabular view listing typical user feature quantities for use by the intervention effect estimation section 41.

The user feature quantities include a user ID, a gender, an age group, and a site visit count. For example, the user feature quantities are stored in the user log storage section 23.

Starting from the top of the list, the feature quantities of the user having a user ID “1001” specify that the user is “female” in gender, is in the age group of “40's,” and visited the site “14 times.”

The feature quantities of the user having a user ID “1002” specify that the user is “male” in gender, is in the age group of “20's,” and visited the site “3 times.”

The feature quantities of the user having a user ID “1003” specify that the user is “male” in gender, is in the age group of “30's,” and visited the site “6 times.”

The feature quantities of the user having a user ID “1004” specify that the user is “female” in gender, is in the age group of “50's,” and visited the site “4 times.”

For example, given the gender, the age group, and the site visit count of each user included in the user feature quantities in FIG. 4, the intervention effect estimation section 41 configures a model for predicting whether or not viewing occurred by use of logistic regression.

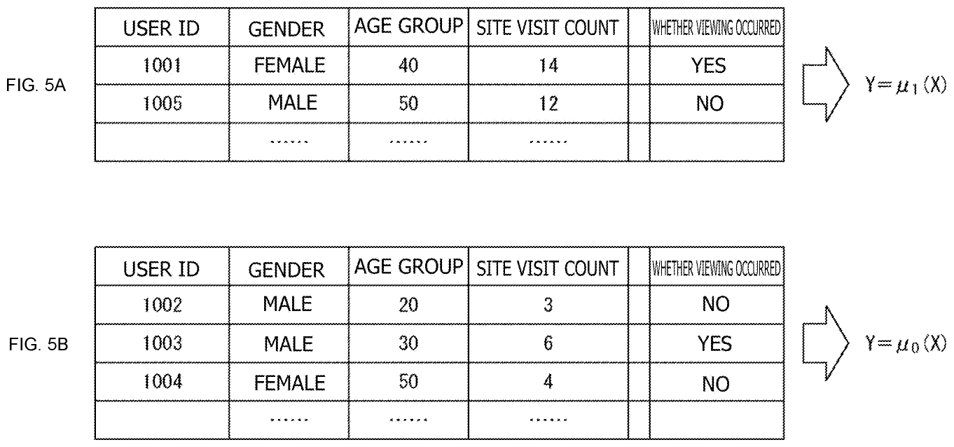

FIG. 5 is a tabular view listing typical configurations of models for estimating intervention effects.

Subfigure A in FIG. 5 indicates an example of configuring the model for estimating the intervention effects using the feature quantities of the users in “the case where there was an intervention.”

Y=μ₁(X) includes the user IDs, genders, age groups, and site visit counts of the users in the case where there was an intervention and from the information as to whether or not viewing occurred as an objective variable with respect to the users.

In Subfigure A of FIG. 5, what is used as the user feature quantities in “the case where there was an intervention” are the feature quantities of the user having a user ID “1001” along with information as to whether viewing by this user occurred, and the feature quantities of the user having a user ID “1005” along with information as to whether viewing by this user occurred.

The feature quantities of the user having the user ID “1001” specify that the user is “female” in gender, is in the age group of “40's,” and visited the site “14 times.” By this user having the user ID “1001,” the viewing “occurred.”

The feature quantities of the user having the user ID “1005” specify that the user is “male” in gender, is in the age group of “50's,” and visited the site “12 times.” By this user having the user ID “1005,” the viewing “did not occur.”

Subfigure B in FIG. 5 indicates an example of configuring the model for estimating the intervention effects using the feature quantities of the users in “the case where there was no intervention.”

Y=μ₀(X) includes the user IDs, genders, age groups, and site visit counts of the users in “the case where there was no intervention” and from the information as to whether viewing occurred as an objective variable with respect to the users.

In Subfigure B of FIG. 5, what is used as the user feature quantities in “the case where there was no intervention” are the feature quantities of the users having user IDs “1002” through “1004,” along with information as to whether viewing by these users occurred.

The feature quantities of the user having the user ID “1002” specify that the user is “male” in gender, is in the age group of “20's,” and visited the site “3 times.” By this user having the user ID “1002,” the viewing “did not occur.”

The feature quantities of the user having the user ID “1003” specify that the user is “male” in gender, is in the age group of “30's,” and visited the site “6 times.” By this user having the user ID “1003,” the viewing “occurred.”

The feature quantities of the user having the user ID “1004” specify that the user is “female” in gender, is in the age group of “50's,” and visited the site “4 times.” By this user having the user ID “1004,” the viewing “did not occur.”

It is noted that, in a case where there were multiple interventions, a model μ₁ₜ(t∈{1, 2, . . . , T}, where T denotes the number of interventions) is configured for each of the interventions.

Using the expression (1) below, the intervention effect estimation section 41 then calculates T(x_{new}) denoting the difference in predicted viewing probability between the case where there was an intervention and the case where there was no intervention, as an intervention effect T regarding a user (x_{new}) not known whether to have made viewing or not.

[Math. 1]

τ(x_{new})=μ₁(x_{new})−μ₀(x_{new}) (1)

### Example of the Estimated Intervention Effect Data

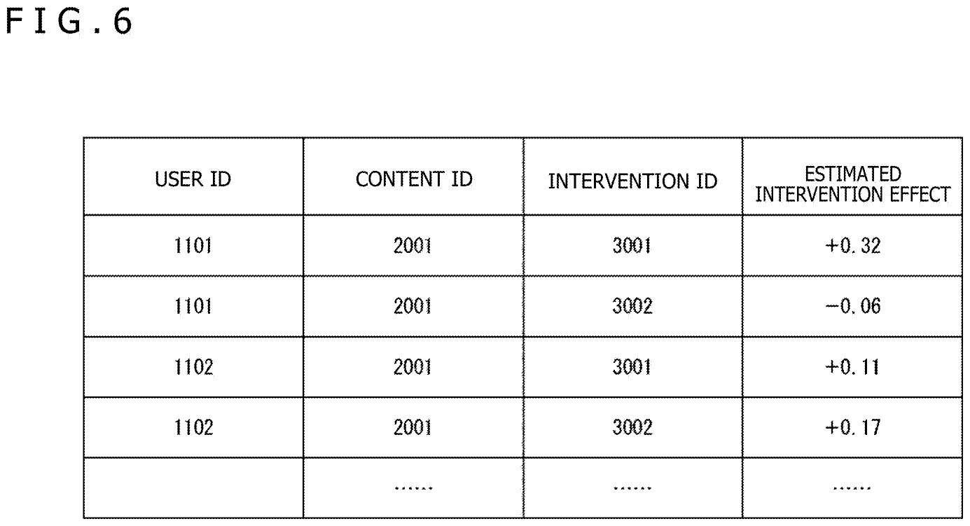

Estimating the intervention effect as described above provides estimated intervention effect data indicative of the estimated result as indicated in FIG. 6.

FIG. 6 is a tabular view indicating configuration examples of the estimated intervention effect data stored in the estimated intervention effect storage section 42.

The estimated intervention effect data associates the estimated intervention effects with the user IDs, the content IDs, and the intervention IDs used for estimating the intervention effects. Here, the estimated intervention effect is expressed by the difference in estimated viewing probability calculated by use of the expression (1) given above.

Starting from the top of the list, a user ID “1101,” a content ID “2001,” and an intervention ID “3001” represent the intervention of which the estimated intervention effect is estimated to be “+0.32.”

The user ID “1101,” the content ID “2001,” and an intervention ID “3002” represent the intervention of which the estimated intervention effect is estimated to be “−0.06.”

A user ID “1102,” the content ID “2001,” and the intervention ID “3001” represent the intervention of which the estimated intervention effect is estimated to be “+0.11.”

A user ID “1102,” the content ID “2001,” and the intervention ID “3002” represent the intervention of which the estimated intervention effect is estimated to be “+0.17.”

<Learning of the Intervention Model>

Explained next is the learning of an intervention model in step S24 in FIG. 2.

The intervention analysis section 43 learns the intervention model representing the relation between the intervention feature quantities and the user feature quantities on one hand and the estimated intervention effects on the other hand. The intervention feature quantities are analyzed beforehand or furnished with relevant information manually before being stored into the intervention material storage section 25.

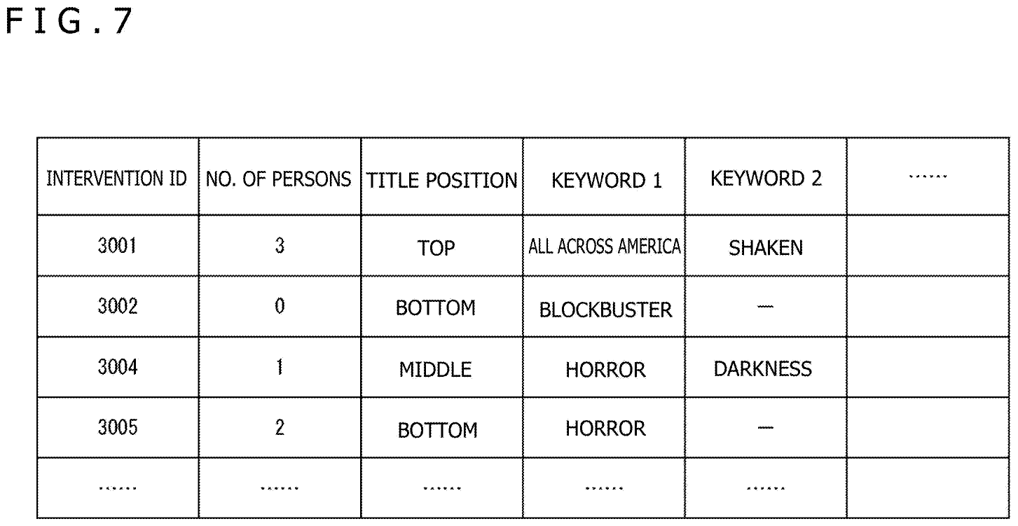

FIG. 7 is a tabular view listing typical feature quantities of interventions stored in the intervention material storage section 25.

In FIG. 7, the feature quantities of an intervention include an intervention ID, the number of persons, a title position, keyword 1, keyword 2, etc. The number of persons denotes how many persons are included in an image within the intervention material used for intervention. The title position denotes the position (top, middle, bottom) in which the title is displayed inside the intervention material. The keywords are words that are optimal for searching for the content constituting the target of intervention.

Starting from the top of the list, the feature quantities of the intervention having an intervention ID “3001” specify that the number of persons is “3,” the title position is “top,” keyword 1 is “all across America,” and keyword 2 is “shaken.”

The feature quantities of the intervention having an intervention ID “3002” specify that the number of persons is “0,” the title position is “bottom,” and keyword 1 is “blockbuster.”

The feature quantities of the intervention having an intervention ID “3004” specify that the number of persons is “1,” the title position is “middle,” keyword 1 is “horror,” and keyword 2 is “darkness.”

The feature quantities of the intervention having an intervention ID “3005” specify that the number of persons is “2,” the title position is “bottom,” and keyword 1 is “horror.”

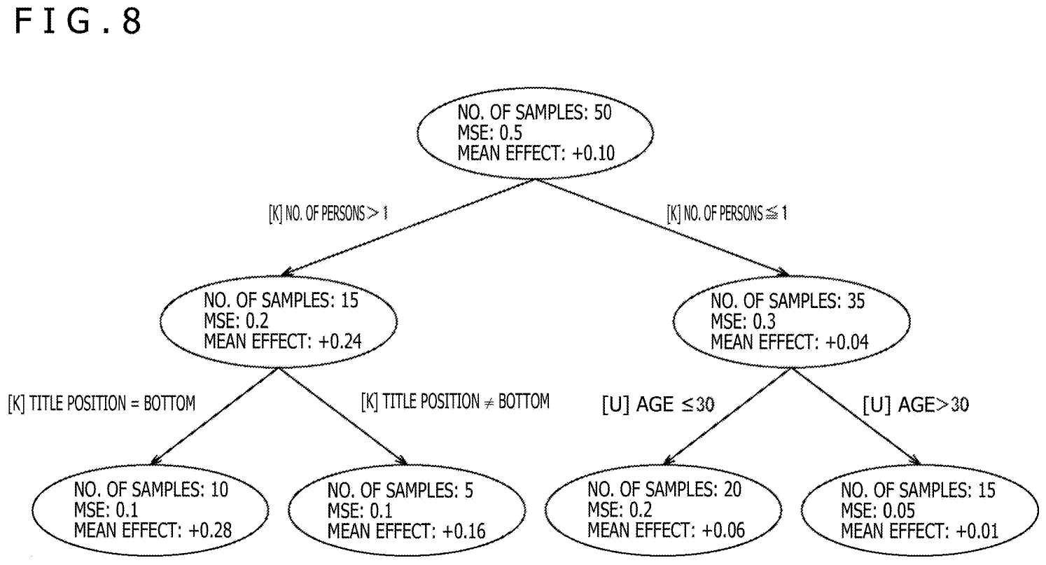

FIG. 8 is a diagram depicting a typical decision tree as a typical intervention model.

The decision tree in FIG. 8 is an exemplary intervention model learned by use of the intervention feature quantities listed in FIG. 7 and the user feature quantities listed in FIG. 4.

Each of the nodes in this decision tree indicates the feature quantities of an intervention, the number of samples in a case where the samples of the intervention are classified on the basis of the feature quantities of the user as the target of the intervention, an MSE (mean square error), and a mean effect.

In FIG. 8, the decision tree includes three tiers: top tier, middle tier, and bottom tier. Each ellipse represents a node. Each node indicates the number of samples, the MSE, and the mean effect at this node. The mean effect indicates an average of the estimated intervention effects at each node. Arrows indicate conditional branches of the samples. Indicated above each arrow is the condition for sample classification. A sign [K] in the figure points to one of the intervention feature quantities. A sign [U] denotes one of the user feature quantities.

At the node in the top tier of the decision tree, the number of samples is “50,” the MSE is “0.5,” and the mean effect is “+0.10.”

Of the samples at the node in the top tier, those with the number of persons being larger than 1 in the intervention material are classified into the left-side node in the middle tier, and those with number of persons being 1 or less in the intervention material are classified into the right-side node in the middle tier.

At the left-side node in the middle tier, the number of samples is “15,” the MSE is “0.2,” and the mean effect is “+0.24.”

At the right-side node in the middle tier, the number of samples is “35,” the MSE is “0.3,” and the mean effect is “+0.04.”

Of the samples at the left-side node in the middle tier, those with the title position being at the bottom in the intervention material are classified into the leftmost node in the bottom tier, and those with the title position not being at the bottom in the intervention material are classified into the second node from left in the bottom tier.

At the leftmost node in the bottom tier, the number of samples is “10,” the MSE is “0.1,” and the mean effect is “+0.28.” At the second node from left in the bottom tier, the number of samples is “5,” the MSE is “0.1,” and the mean effect is “+0.16.”

Of the samples at the right-side node in the middle tier, those with the user's age being 30 or less are classified into the third node from left in the bottom tier, and those with the user's age being over 30 are classified into the fourth node from left in the bottom tier.

At the third node from left in the bottom tier, the number of samples is “20,” the MSE is “0.2,” and the mean effect is “+0.06.” At the fourth node from left in the bottom tier, the number of samples is “15,” the MSE is “0.05,” and the mean effect is “+0.01.”

From the decision tree in FIG. 8, it can be seen that the mean effect is the highest at the leftmost node in the bottom tier and the lowest at the fourth node from left in the bottom tier. That is, using the decision tree makes it possible, in the generation of intervention materials, to easily obtain the feature quantities of highly effective interventions and the feature quantities of the users.

It is noted that, whereas the estimation of the intervention effect (step S23) and the learning of the intervention model (step S24) are presented as different processes in FIG. 2, these two processes may alternatively be carried out collectively. That is, whereas the information processing section 24 in FIG. 1 has the intervention effect estimation section 41 and the intervention analysis section 43 as distinct from each other, the intervention effect estimation section 41 may alternatively include the intervention analysis section 43 in this case. In other words, the intervention effect estimation section 41 and the intervention analysis section 43 may be reconfigured as a single processing section. In this case, the intervention effect estimation section 41 also includes the estimated intervention effect storage section 42.

<Generation of the Intervention Material>

The generation of the intervention material in step S25 in FIG. 2 is explained next.

The intervention material generation section 45 presents intervention material parts using the intervention feature quantities and the user feature quantities corresponding to the samples at the node offering high intervention effects in the decision tree in FIG. 8, for example. The intervention material generation section 45 generates the intervention material by combining the presented intervention material parts in response to the creator's operations.

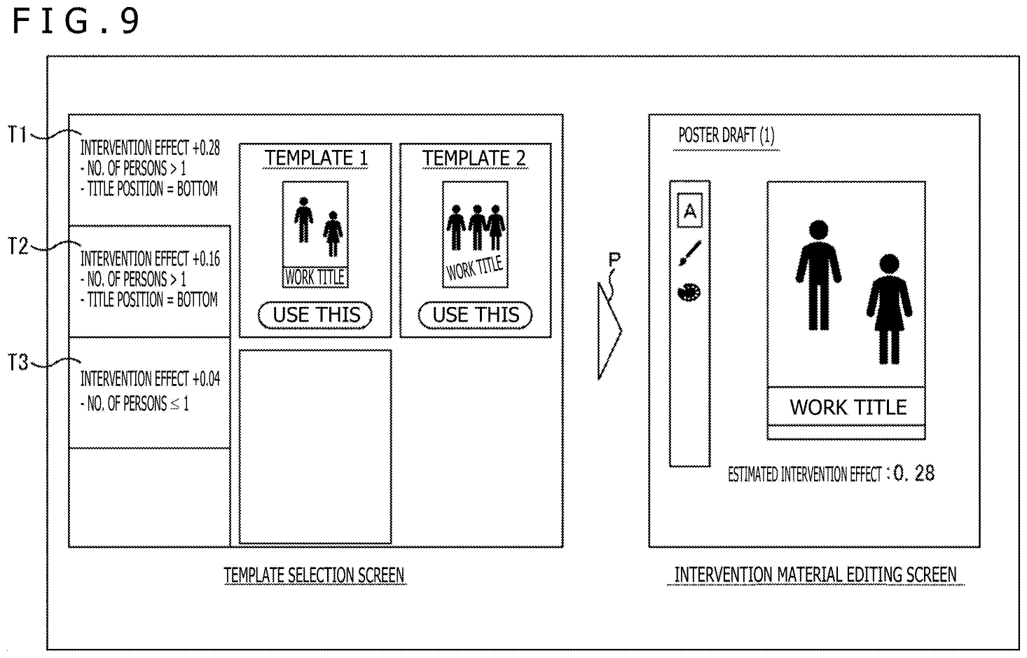

FIG. 9 is a diagram depicting a typical intervention material editing screen.

A template selection screen is depicted on the left in FIG. 9, and an intervention material editing screen is indicated on the right. It is noted that a movie poster etc. may presumably be used as the intervention material.

On the template selection screen, the templates matching the intervention feature quantities corresponding to the samples at the nodes providing high intervention effects (mean effects) in the decision tree in FIG. 8 are read from the template storage section 46. The templates thus retrieved are presented to the creator. It is noted that, in a case where the user feature quantities are used in the decision tree, the templates are read out also on the basis of the user feature quantities.

The templates are stored beforehand in the template storage section 46 along with template-related information.

A central part of the template selection screen in FIG. 9 displays template 1 and template 2 matching the conditions (intervention feature quantities) at the leftmost node in the bottom tier of the decision tree in FIG. 8. A use button indicative of the wording “USE THIS” is displayed under each of template 1 and template 2. Pressing the use button selects the template displayed above the button. Also, pressing the use button causes the template selection screen to transition, as indicated by arrow P, to an intervention material editing screen that uses the template selected by pressing the use button.

In the top left corner of the selection screen, a tab T1 is indicated. The tab T1 displays “Intervention Effect+0.28; Number of Persons>1; Title Position=Bottom” as the intervention effect and conditions (intervention feature quantities) at the leftmost node in the bottom tier of the decision tree in FIG. 8.

A tab T2 is indicated under the tab T1. The tab T2 displays “Intervention Effect+0.16; Number of Persons >1; Title Position=Bottom” as the intervention effect and conditions at the second node from left in the bottom tier of the decision tree in FIG. 8. Selecting the tab T2 displays the template matching the conditions of this node together with the use button at the central part of the selection screen.

A tab T3 is indicated under the tab T2. The tab T3 displays “Intervention Effect+0.04; Number of Persons ≤1” as the intervention effect and conditions at the third node from left in the bottom tier of the decision tree in FIG. 8. Selecting the tab T3 displays the template matching the conditions of this node together with the use button at the central part of the selection screen.

The intervention material editing screen displays the template selected on the template selection screen. Editing tools are displayed on the left of the template. The creator can edit the template in detail using the displayed editing tools.

It is noted that, in a case where any condition of the intervention model is associated with what is not embedded beforehand in the intervention material such as a keyword, an indication such as “Recommended Keyword: “All across America” may be arranged to be displayed on the intervention material editing screen. This allows the creator to know that the displayed keyword is associated with this template.

In a case where editing the template changes the intervention effect predicted by the intervention model, the intervention material editing screen may be arranged to display the intervention effect predicted in real time.

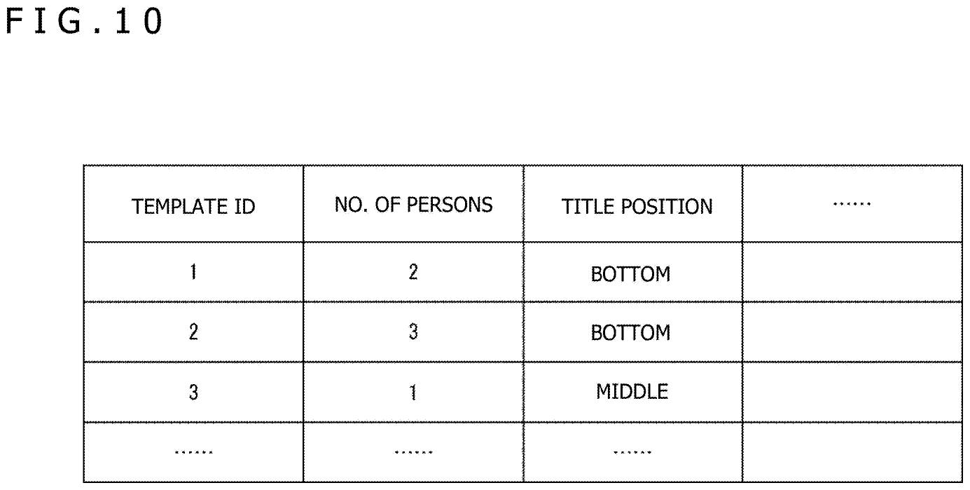

FIG. 10 is a tabular view listing typical templates stored in the template storage section 46.

The first template information at the top of the list indicates that the template ID is “1,” the number of persons is “2,” and the title position is “bottom.” The second template information from the top indicates that the template ID is “2,” the number of persons is “3,” and the title position is “bottom.” The third template information from the top indicates that the template ID is “3,” the number of persons is “1,” and the title position is “middle.”

The creator selects a favorably regarded template from among the presented templates on the template selection screen, and edits the selected template on the intervention material editing screen.

The intervention material generated by editing on the editing screen is stored into the intervention material storage section 25. In a case where the conditions at the node corresponding to the template include a user feature quantity, the user feature quantity is also stored in association with the generated intervention material.

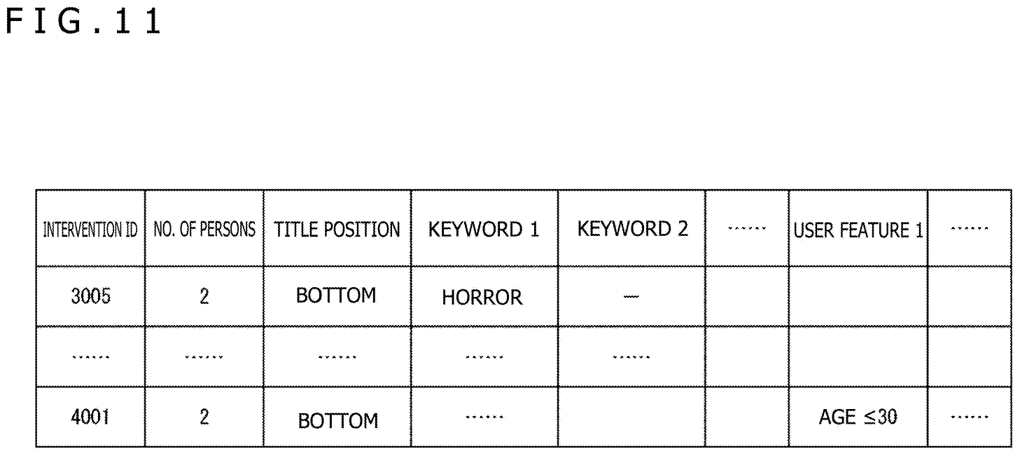

FIG. 11 is a tabular view listing typical intervention material information stored in the intervention material storage section 25.

The intervention material information includes the intervention ID, the number of persons, the title position, keyword 1, . . . , user feature 1, etc.

The intervention material information for an intervention ID “3005” indicates that the number of persons is “2,” the title position is “bottom,” and keyword 1 is “horror.” The intervention material information for an intervention ID “4001” indicates that the number of persons is “2,” the title position is “bottom,” and user feature 1 is “age <30.”

It is noted that the templates may be prepared manually in advance. Alternatively, the templates may be automatically generated by extracting the intervention material parts matching the feature quantities having high ratios of contribution to intervention effects and by combining the extracted parts with other intervention material parts as needed.

In the latter case, for example, in a case where the intervention model such as the decision tree in FIG. 8 has been generated and where the target of intervention is video content, a human detection technique is used on the video content to extract therefrom a series of scenes matching the conditions of each node. A face position detection technology is then used to arrange the extracted scenes in such a manner that the title does not overlap with persons' faces and is placed in a position meeting the conditions of the node on an image divided into three parts, i.e., top, middle, and bottom parts. The template is thus generated automatically.

It is noted that the learning of the intervention model and the generation of the intervention material described above may be carried out collectively using a single model. That is, whereas the information processing section 24 in FIG. 1 has the intervention analysis section 43 and the intervention material generation section 45 as distinct from each other, the intervention analysis section 43 and the intervention material generation section 45 may alternatively be reconfigured as a single processing section. In this case, the intervention model storage section 44 may be omitted.

In a case where the above two sections are reconfigured as one processing section, the intervention analysis section 43 and the intervention material generation section 45 is configured, for example, by Conditional GAN (Generative Adversarial Nets). Conditional GAN is described, for example, in Literature 1 (Mirza, M., et al., “Conditional Generative Adversarial Nets,” arXiv, 6 Nov. 2014, [searched on Oct. 8, 2020]; Internet <URL: https://arxiv.org/abs/1411.1784>).

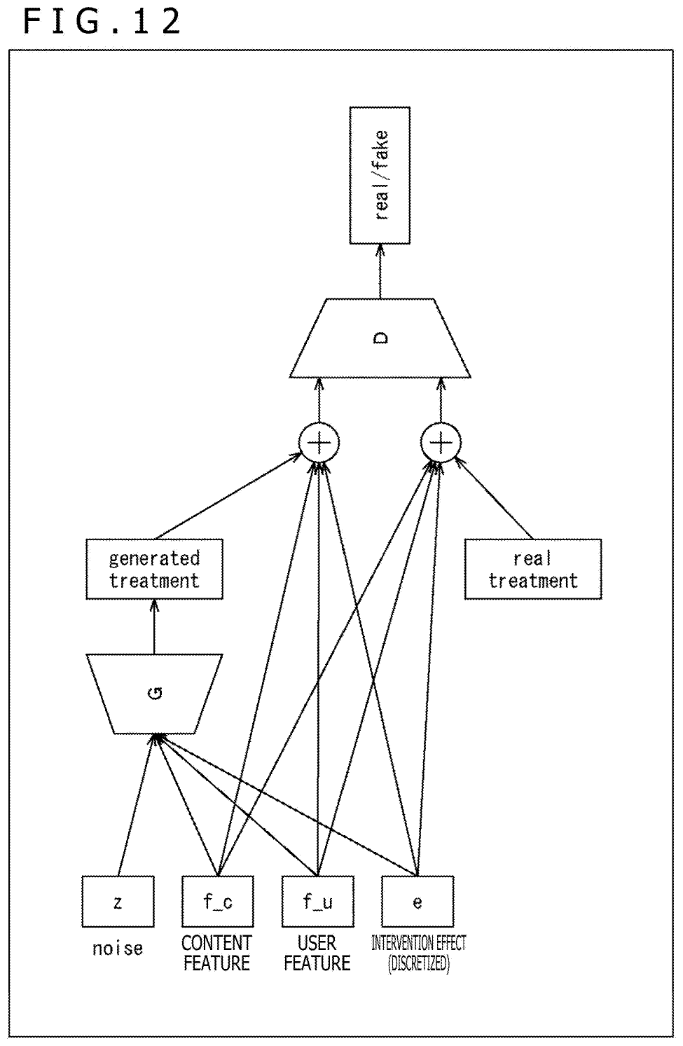

FIG. 12 is a diagram depicting an example of Conditional GAN.

Conditional GAN in FIG. 12 learns a neural network which receives input of a random noise z, a content feature f_c, a user feature f_u, and an intervention effect and which outputs an intervention feature (or an intervention material itself). Conditional GAN then generates an intervention material that can be expected to provide a high intervention effect on the target content.

Conditional GAN includes a generator G and a discriminator D.

The generator G receives input of a random noise z, a content feature f_c, a user feature f_u, and an intervention effect “e,” and produces a generated treatment (intervention material). For example, values discretized in five steps may be used as the intervention effect “e.”

Using “real (true)” or “fake (false)” as training data, the discriminator D discriminates the sum of the generated treatment produced by the generator G, the content feature f_c, the user feature f_u, and the intervention effect “e” from the sum of a real treatment (existing intervention material), the content feature f_c, the user feature f_u, and the intervention effect “e,” and outputs “real” or “fake.” The discriminator D learns the above-described discrimination using “real” or “fake” as the training data.

That is, the discriminator D learns to output the “generated treatment” not distinguishable from the “real treatment” by the generator G. When the intervention material is generated in practice, only the generator G and the generator D from among discriminators is used.

The intervention material generated in the manner described above is confirmed by the content distribution business operator, by the content owner, etc.

<Confirmation of the Intervention>

Finally, the confirmation of intervention in step S26 in FIG. 2 is explained.

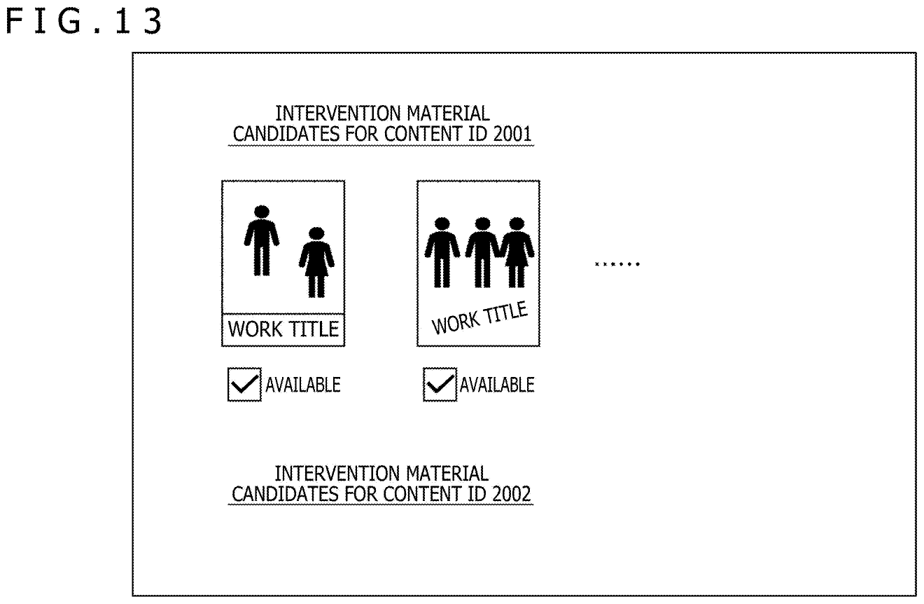

FIG. 13 is a diagram depicting a typical intervention confirmation screen.

Two intervention material candidates for a content ID “2001” are indicated in FIG. 13. Displayed under each intervention material candidate is a check button that indicates availability of the candidate when checked and unavailability when unchecked.

For example, by viewing the intervention confirmation screen, the content distribution business operator confirms whether or not each intervention material candidate meets the requirements explained below. In a case where a given intervention material candidate fails to meet the requirements, the content distribution business operator unchecks the check button to ban the use of the intervention material candidate.

It is noted that, in a case where the above-described intervention material was manually generated, the intervention confirmation is not mandatory.

Here, it is possible automatically to determine beforehand (or without manual confirmation) whether a given intervention material meets the requirements and to delete the intervention material determined to have failed. For example, a discriminator trained beforehand to detect cases (1) through (3) below may be employed.
(1) Detection of an infringement on an intellectual property. In this case, what is measured, for example, is the degree of similarity between parts of the intervention material on one hand and logo marks and characters of the competition on the other hand. If the measured degree of similarity exceeds a predetermined threshold level, the intervention material part is deleted.
(2) Detection of the degree of similarity to other intervention material parts. In this case, the degree of similarity of the entire intervention material is measured. If the measured degree of similarity exceeds a predetermined threshold level, the intervention material is deleted.
(3) Detection of whether the intervention material is against public order and standards of decency. In this case, the entity that performs confirmation (e.g., a content distribution business operator or a content owner) defines beforehand extreme expressions that are deemed against public order and standards of decency and, if any such extreme expression determined to be improper is detected from the intervention material, deletes that intervention material.

The intervention material is generated and confirmed as described above, before being used by the intervention section 21 for intervention.

At the time of the intervention, in a case where the intervention effect estimation section 41 estimates the intervention effect with individual users, the intervention effect estimation section 41 may reference the intervention material storage section 25 for the user feature quantities (FIG. 11) matching the individual users in order to select an optimal intervention material for each user.

Also, at the time of the intervention, in a case where there are multiple intervention materials for use in the intervention, the intervention materials may be presented in descending order of estimated intervention effects.

In the manner described above, the intervention processing system 11 can perform more effective interventions than before.

### 2. Variations

<Variation of the Intervention Processing System>

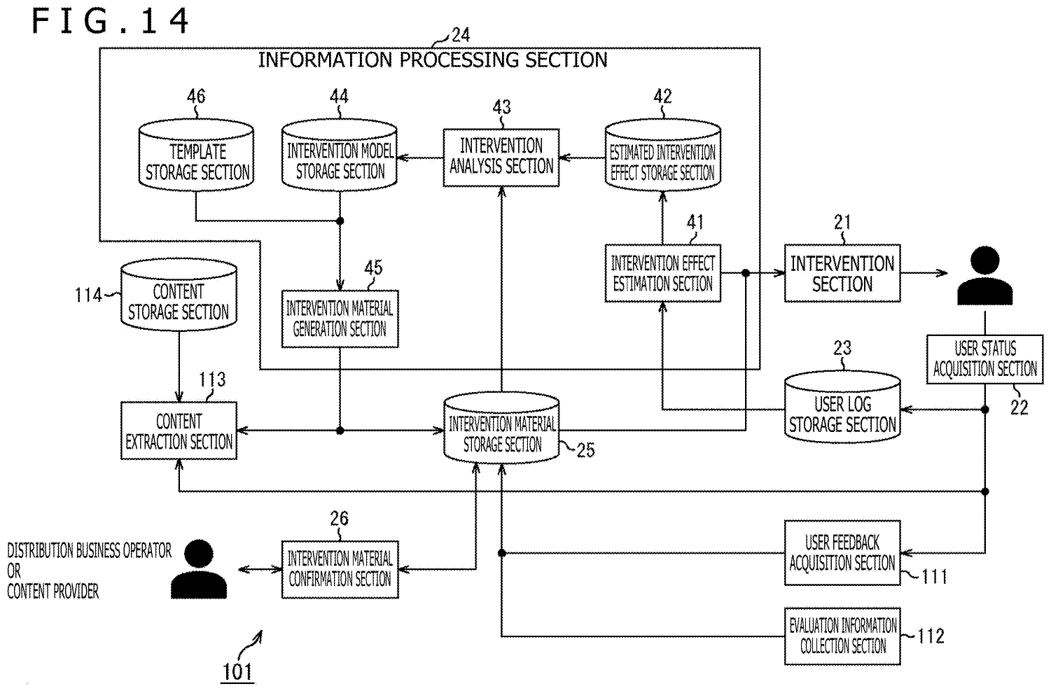

FIG. 14 is a block diagram depicting a variation of the intervention processing system in FIG. 1.

An intervention processing system 101 in FIG. 14 differs from the intervention processing system 11 in FIG. 1 in that a user feedback acquisition section 111, an evaluation information collection section 112, a content extraction section 113, and a content storage section 114 are added anew.

The sections in FIG. 14 that correspond to those in FIG. 1 are designated by the corresponding reference signs, and their explanations will not be repeated hereunder as they are redundant. Also, the intervention processing system 101 performs basically the similar processing as the intervention processing system 11 in FIG. 1.

The user feedback acquisition section 111 stores reviews and evaluations by the user out of the information supplied from the user status acquisition section 22 into the intervention material storage section 25 as intervention materials themselves or as parts thereof in a manner asynchronous with the processing in FIG. 2. At this time, statistical information such as the number of users having pressed the approval button (Like) and the mean evaluation values may also be stored into the intervention material storage section 25.

At the time of the intervention, the reviews or evaluations are presented as one type of intervention material along with other types of intervention materials, for example. In a case where there are numerous reviews or evaluations, the top N reviews or evaluations in descending order of estimated intervention effects may be presented. Alternatively, only the reviews or evaluations having the estimated intervention effects equal to or higher than a predetermined level may be presented. When presented with the reviews or evaluations in descending order of intervention effects, the user on the viewing side finds it easy to view them.

The evaluation information collection section 112 stores evaluation information obtained from servers of external services such as SNS into the intervention material storage section 25 beforehand as intervention materials or parts thereof in a manner asynchronous with the processing in FIG. 2.

The evaluation information is information that includes in hashtags the character strings of the title of the designated content, names of the actors appearing in the content, and names of production staffs including the director. Preferably, at the time of evaluation information acquisition, only the information regarding positive evaluations may be acquired using techniques such as sentiment analysis.

At the time of evaluation information presentation, the evaluation information may be embedded in a prepared template such as “(A given number of persons) are commenting on SNS,” or “Of (a given number of persons), (a given number of persons) are making positive evaluations on SNS.” Alternatively, out of the evaluation information, posts involving numerous references (e.g., fav and retweet on Twitter) may specifically be presented unmodified as intervention materials in content detail pages of the service.

The content extraction section 113 acquires, from the user status acquisition section 22, the user's reactions to the content in a manner asynchronous with the processing in FIG. 2.

The user's reactions refer to information acquired from the user's operations, statistical information regarding the user, and changes in the user's facial expression, perspiration, or other behavior obtained by sensors. For example, the user's reactions constitute information regarding at what point the user was found specifically interested in the content (video or music) being played in the time direction.

The statistical information is information regarding how the user acted, for example, on video and music such as starts, stops, and pauses or on books such as the time taken by the user on each of the pages.

In reference to the user's reactions, the content extraction section 113 extracts an intervention material or a part thereof from the content storage section 114 or from the content in a server, not depicted, and stores what is extracted into the intervention material storage section 25.

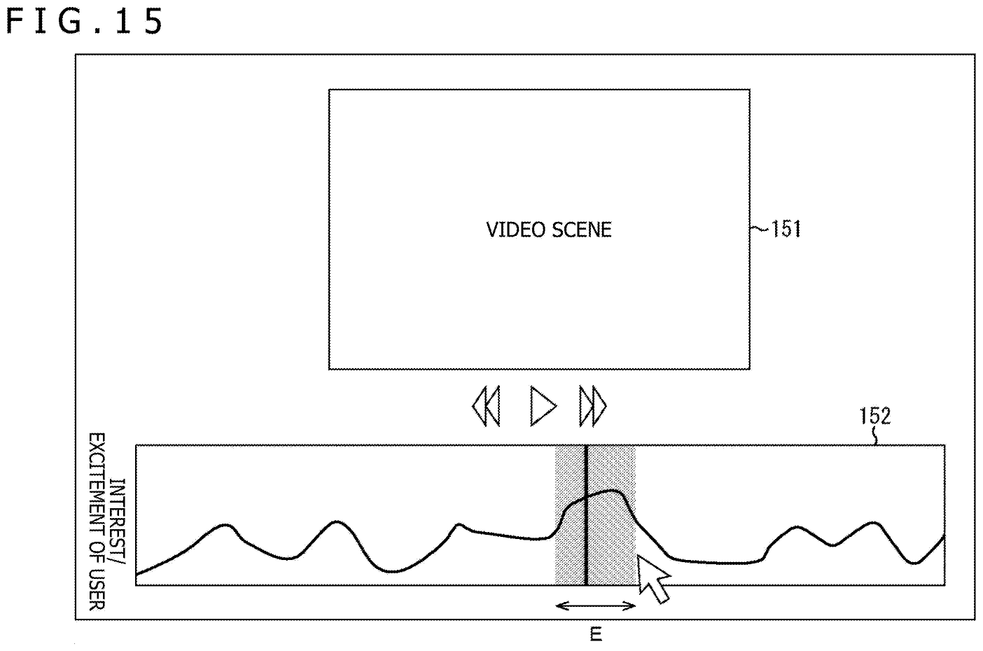

FIG. 15 is a diagram depicting a typical extraction/editing screen for extracting intervention materials from the content.

A video display section 151 for video display is arranged in the upper part of the extraction/editing screen in FIG. 15. Arranged under the video display section 151 are rewind, play, and fast-forward operation buttons. Under the operation buttons, arranged is a timeline display section 152 that displays the video timeline.

As time advances, the timeline display section 152 displays a waveform indicative of the user's interest and excitement based on the user's reactions acquired from the user status acquisition section 22.

The extraction/editing screen configured as described above visualizes the user's reactions along the time axis of the content. In response to the operations of the user viewing the extraction/editing screen, the content extraction section 113 generates an intervention material or a part thereof by extracting and editing a portion of the content indicated in a segment E, for example.

### 3. Second Embodiment

It is noted that described above is the embodiment for the user receiving offerings of the content distribution service. However, this is not limitative of the present technology. Alternatively, interventions may also be performed with users receiving offerings of other services. One of such services is a healthcare-related service for keeping the user in good health. Explained below is how this service may be typically practiced with this technology.

### Another Configuration Example of the Intervention Processing System

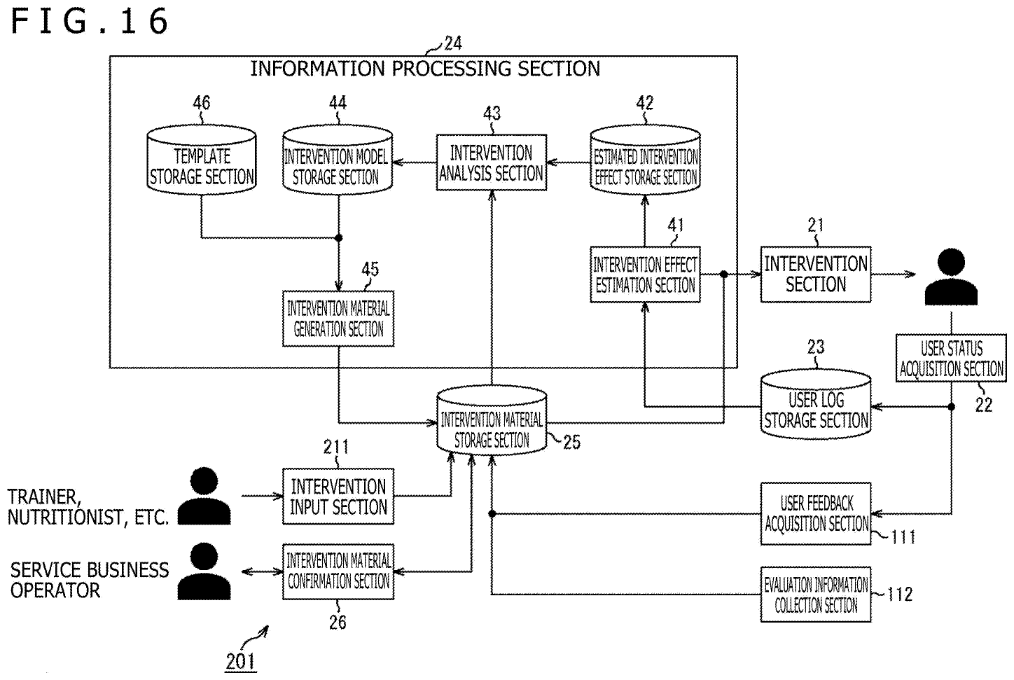

FIG. 16 is a block diagram depicting a functional configuration of an intervention processing system as a second embodiment of the present technology.

An intervention processing system 201 in FIG. 16 performs interventions with the user receiving offerings of the healthcare-related service.

The sections in FIG. 16 that correspond to those in FIGS. 1 and 14 are designated by the corresponding reference signs, and their explanations will not be repeated hereunder as they are redundant.

It is noted that the intervention processing system 201 differs from the intervention processing system 101 in that an intervention material input section 211 is newly added and that the content extraction section 113 and the content storage section 114 are removed. Also, the intervention processing system 201 is different from the intervention processing system 101 in that the target confirming the intervention material is changed from the distribution business operator or the content provider to the service business operator.

In the intervention processing system 201 in FIG. 16, pieces of advice and encouragements from experts such as a trainer and a nutritionist can be used as an intervention material or a part thereof. The intervention material input section 211 thus receives input of the advice and encouragements corresponding to the operations made by the trainer and nutritionist, for example, as the intervention materials or parts thereof.

The processes other than the input of intervention materials or parts thereof by the intervention processing system 201 are basically the similar processes carried out by the intervention processing system 101 in FIG. 1, and their explanations will not be repeated hereunder as they are redundant.

### 4. Others

<Effects of the Present Technology>

The present technology permits estimation of an intervention effect obtained as a result of performing an intervention, and, on the basis of the estimated intervention effect, allows an intervention material to be generated for use in a new intervention.

This makes it possible to perform highly effective interventions.

The intervention effect is estimated for each individual.

That in turn makes it possible to carry out more detailed interventions.

Further, the intervention materials are generated in response to the user's operations.

Such human intervention makes it possible to generate intervention materials that provide convincing effects.

<Typical Computer Configuration>

The series of processes described above may be executed either by hardware or by software. In a case where a software-based series of processing is to be carried out, the programs constituting the software are installed into a suitable computer built with dedicated hardware or into a general-purpose computer or like equipment from a program recording medium.

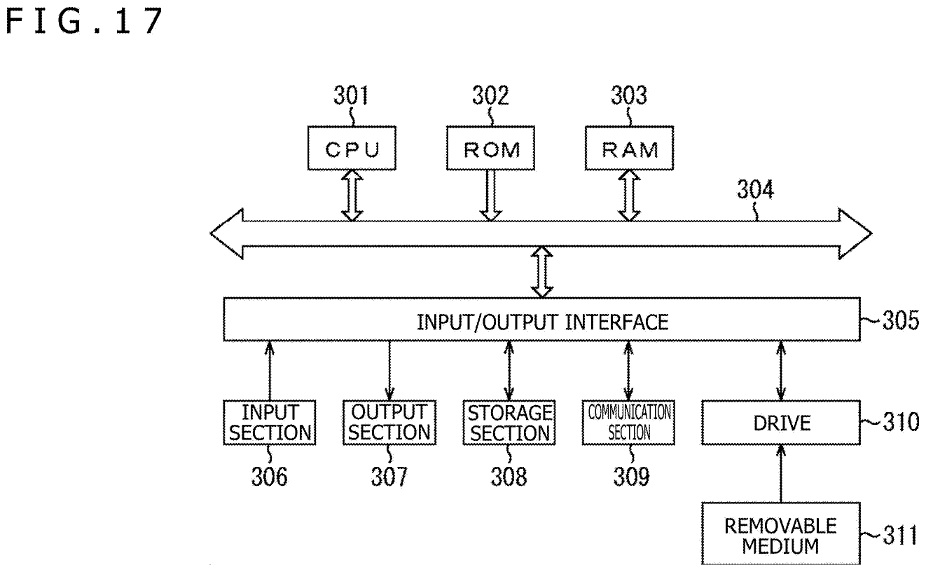

FIG. 17 is a block diagram depicting a typical hardware configuration of a computer that carries out the above-described series of processes using programs.

A CPU 301, a ROM (Read Only Memory) 302, and a RAM 303 are interconnected via a bus 304.

The bus 304 is further connected with an input/output interface 305. The input/output interface 305 is connected with an input section 306 including a keyboard and a mouse and with an output section 307 including a display unit and speakers. The input/output interface 305 is further connected with a storage section 308 including a hard disk and a nonvolatile memory, with a communication section 309 including a network interface, and with a drive 310 that drives a removable medium 311.

In the computer configured as described above, the CPU 301 performs the above-mentioned series of processing by loading appropriate programs from the storage section 308 into the RAM 303 via the input/output interface 305 and the bus 304 and by executing the loaded programs.

The programs to be executed by the CPU 301 are recorded, for example, on the removable medium 311 when offered for installation into the storage section 308. The programs are also offered via wired or wireless transmission medium such as local area networks, the Internet, and digital satellite broadcasting, before being installed into the storage section 308.

It is noted that the programs executed by the computer may each be processed chronologically, i.e., in the sequence explained in this description, in parallel with other programs, or in otherwise appropriately timed fashion such as when the program is invoked as needed.

It is noted that, in this description, the term “system” refers to an aggregate of multiple components (e.g., apparatuses or modules (parts)). It does not matter whether or not all components are housed in the same enclosure. Thus, a system includes multiple apparatuses housed in separate enclosures and is interconnected via a network, or with a single apparatus in a single enclosure that houses multiple modules.

The advantageous effects stated in this description are only examples and not limitative of the present technology that may provide other advantages as well.

The present technology is not limited to the preferred embodiments discussed above and can be implemented in diverse variations so far as they are within the scope of this technology.

For example, the present technology may be implemented as a cloud computing setup in which a single function is processed cooperatively by networked multiple apparatuses on a shared basis.

Also, each of the steps discussed in reference to the above-described flowchart may be executed either by a single apparatus or by multiple apparatuses on a shared basis.

Furthermore, in a case where a single step includes multiple processes, these processes can be executed either by a single apparatus or by multiple apparatuses on a shared basis.

<Exemplary Combinations of the Configured Components>

The present technology may be implemented preferably in the following configurations.

(1)

An information processing apparatus including:
an information processing section configured to estimate an intervention effect obtained as a result of performing an intervention and, on the basis of the estimated intervention effect, to generate an intervention material for use in a new intervention to be performed.
   (2)

The information processing apparatus according to (1), in which
the information processing section includes
an intervention effect estimation section configured to estimate the intervention effect,
a learning section configured to learn an intervention model representing a relation between the estimated intervention effect and a feature quantity of the intervention, and
an intervention material generation section configured to generate the intervention material based on the intervention model.
   (3)

The information processing apparatus according to (2), in which the intervention effect estimation section estimates the intervention effect regarding an individual user.

(4)

The information processing apparatus according to (2), in which
the intervention model represents a relation between the intervention effect on one hand and the feature quantity of the intervention and a feature quantity of a user on the other hand.
   (5)

The information processing apparatus according to (2), in which
the learning section learns the intervention model by use of a machine learning method having interpretability.
   (6)

The information processing apparatus according to (2), in which,
using the intervention model, the intervention material generation section sets the feature quantity of the intervention for use in generating the intervention material on the basis of the intervention effect regarding the feature quantity of the intervention.
   (7)

The information processing apparatus according to (6), in which
the intervention material generation section generates the intervention material in response to an operation by a user.
   (8)

The information processing apparatus according to any one of (1) to (7), further including:
an intervention section configured to perform the intervention by use of the intervention material.
   (9)

The information processing apparatus according to any one of (1) to (8), further including:
a user log storage section configured to store information regarding an action of a user, in which
the information processing section estimates the intervention effect by use of information regarding the action of the user, which is performed for the intervention, and information regarding the action of the user in a case where the intervention is not performed.
   (10)

The information processing apparatus according to (9), in which
the information regarding the action of the user is obtained from a sensor attached to a user terminal.
   (11)

The information processing apparatus according to (9), in which
the information regarding the action of the user is obtained from a UI (User Interface) provided on a user terminal.
   (12)

The information processing apparatus according to any one of (1) to (11), in which
the information processing section generates the intervention material including multiple parts.
   (13)

The information processing apparatus according to (12), further including:
a detection section configured to detect whether or not a predetermined condition is met by the generated intervention material or by the parts, in which,
in a case where the predetermined condition is detected to be met, the use of the intervention material or of the parts is banned.
   (14)

The information processing apparatus according to (13), in which
the predetermined condition includes an infringement on an intellectual property, a similarity to another intervention material, or a violation of public order and standards of decency.
   (15)

The information processing apparatus according to (12), further including:
a user feedback acquisition section configured to acquire feedback information from a user regarding the intervention as the intervention material or as the parts.
   (16)

The information processing apparatus according to (12), further including:
an evaluation information collection section configured to collect evaluation information from an external server as the intervention material or as the parts.
   (17)

The information processing apparatus according to (12), further including:
a content extraction section configured such that, on the basis of details of content, the content extraction section extracts a portion of the content as the intervention material or as the parts.
   (18)

The information processing apparatus according to (12), further including:
an intervention material input section configured to receive input of information regarding advice or encouragement from an expert as the intervention material or as the parts.
   (19)

The information processing apparatus as stated in (1) above, in which
the information processing section includes
   an intervention effect estimation section configured to estimate the intervention effect and to learn an intervention model representing a relation between the estimated intervention effect and a feature quantity of the intervention, and
   an intervention material generation section configured to generate the intervention material based on the intervention model.
      (20)

The information processing apparatus as stated in (1) above, in which
the information processing section includes
   an intervention effect estimation section configured to estimate the intervention effect, and
   an intervention material generation section configured to learn the intervention material using the estimated intervention effect in order to generate the intervention material.
      (21)

The information processing apparatus as stated in (1) above, in which
the information processing section includes
   an intervention effect estimation section configured to estimate the intervention effect, and
   an intervention material generation section configured to learn a feature quantity of the intervention using the estimated intervention effect in order to generate the intervention material based on the generated feature quantity of the intervention.
      (22)

An information processing method including:
causing an information processing apparatus to estimate an intervention effect obtained as a result of performing an intervention and, on the basis of the estimated intervention effect, to generate an intervention material for use in a new intervention to be performed.
   (23)

A program for causing a computer to function as:
an information processing section that estimates an intervention effect obtained as a result of performing an intervention and, on the basis of the estimated intervention effect, generates an intervention material for use in a new intervention to be performed.

### REFERENCE SIGNS LIST

11: Intervention processing system
21: Intervention section
22: User status acquisition section
23: User log storage section
24: Information processing section
25: Intervention material storage section
26: Intervention confirmation section
41: Intervention effect estimation section
42: Estimated intervention effect storage section
43: Intervention analysis section
44: Intervention model storage section
45: Intervention material generation section
46: Template storage section
101: Intervention processing system
111: User feedback acquisition section
112: Evaluation information acquisition section
113: Content extraction section
114: Content storage section
201: Intervention processing system
211: Intervention material input section

1. An information processing apparatus comprising:
an information processing section configured to estimate an intervention effect obtained as a result of performing an intervention and, on a basis of the estimated intervention effect, to generate an intervention material for use in a new intervention to be performed.

2. The information processing apparatus according to claim 1, wherein
the information processing section includes
an intervention effect estimation section configured to estimate the intervention effect,
a learning section configured to learn an intervention model representing a relation between the estimated intervention effect and a feature quantity of the intervention, and
an intervention material generation section configured to generate the intervention material based on the intervention model.

3. The information processing apparatus according to claim 2, wherein
the intervention effect estimation section estimates the intervention effect regarding an individual user.

4. The information processing apparatus according to claim 2, wherein
the intervention model represents a relation between the intervention effect on one hand and the feature quantity of the intervention and a feature quantity of a user on the other hand.

5. The information processing apparatus according to claim 2, wherein
the learning section learns the intervention model by use of a machine learning method having interpretability.

6. The information processing apparatus according to claim 2, wherein,
using the intervention model, the intervention material generation section sets the feature quantity of the intervention for use in generating the intervention material on a basis of the intervention effect regarding the feature quantity of the intervention.

7. The information processing apparatus according to claim 6, wherein
the intervention material generation section generates the intervention material in response to an operation by a user.

8. The information processing apparatus according to claim 1, further comprising:
an intervention section configured to perform the intervention by use of the intervention material.

9. The information processing apparatus according to claim 1, further comprising:
a user log storage section configured to store information regarding an action of a user, wherein
the information processing section estimates the intervention effect by use of information regarding the action of the user in a case where the intervention is performed and information regarding the action of the user in a case where the intervention is not performed.

10. The information processing apparatus according to claim 9, wherein
the information regarding the action of the user is obtained from a sensor attached to a user terminal.

11. The information processing apparatus according to claim 9, wherein
the information regarding the action of the user is obtained from a UI (User Interface) provided on a user terminal.

12. The information processing apparatus according to claim 1, wherein
the information processing section generates the intervention material including multiple parts.

13. The information processing apparatus according to claim 12, further comprising:
a detection section configured to detect whether or not a predetermined condition is met by the generated intervention material or by the parts, wherein,
in a case where the predetermined condition is detected to be met, the use of the intervention material or of the parts is banned.

14. The information processing apparatus according to claim 13, wherein
the predetermined condition includes an infringement on an intellectual property, a similarity to another intervention material, or a violation of public order and standards of decency.

15. The information processing apparatus according to claim 12, further comprising:
a user feedback acquisition section configured to acquire feedback information from a user regarding the intervention as the intervention material or as the parts.

16. The information processing apparatus according to claim 12, further comprising:
an evaluation information collection section configured to collect evaluation information from an external server as the intervention material or as the parts.

17. The information processing apparatus according to claim 12, further comprising:
a content extraction section configured such that, on a basis of details of content, the content extraction section extracts a portion of the content as the intervention material or as the parts.

18. The information processing apparatus according to claim 12, further comprising:
an intervention material input section configured to receive input of information regarding advice or encouragement from an expert as the intervention material or as the parts.

19. An information processing method comprising:
causing an information processing apparatus to estimate an intervention effect obtained as a result of performing an intervention and, on a basis of the estimated intervention effect, to generate an intervention material for use in a new intervention to be performed.

20. A program for causing a computer to function as:
an information processing section that estimates an intervention effect obtained as a result of performing an intervention and, on a basis of the estimated intervention effect, generates an intervention material for use in a new intervention to be performed.
